(19) United States
(12) Patent Application Publication
(10) Pub. No.: US 2023/0067047 A1
(43) Pub. Date: Mar. 2, 2023

(54) LIGHT AND MOISTURE CURABLE COMPOSITIONS

(71) Applicant: 3M INNOVATIVE PROPERTIES COMPANY, St.. Paul, MN (US)

(72) Inventors: Katherine A. Gibney, St. Paul, MN (US); Ying Lin, Superior, CO (US)

(21) Appl. No.: 17/789,465

(22) PCT Filed: Dec. 21, 2020
(86) PCT No.: PCT/IB2020/062292

§ 371 Date: Jun. 27, 2022

Related U.S. Application Data
(60) Provisional application No. 62/954,967, filed on Dec. 30, 2019.

(51) Int. Cl. C08F 283/00; C08K 13/02; C09D 175/16; C09J 175/16; C09J 7/28; C09J 7/38; B32B 15/01

(52) U.S. Cl. CPC C08F 283/008; C08K 13/02; C09D 175/16; C09J 175/16; C09J 7/28; C09J 7/38; B32B 15/011; C09J 2400/163; C09J 2475/00; C09J 2451/00; B32B 2255/06; B32B 2255/26; B32B 2307/748; B32B 2307/714

(57) ABSTRACT

Curable compositions comprising a urethane multifunctional (meth)acrylate, a photo initiator system, a moisture-cure initiator, and an oligomer, where the oligomer is represented by the formula (I) where each X¹ is independently alkylene; each X² is independently alkylene, polyether, polyester, or polyurethane; R¹ is a (meth)acrylate; R² is urethane or isocyanate; and R³ alkylene (meth)acrylate, polyester (meth)acrylate, polyether, polyester, polyurethane, or nothing, and where the ratio of (meth)acrylate to isocyanate in the oligomer is 1:1 to 1:2. Methods of making curable compositions, methods of sealing a substrate, and methods of adhering two substrates are provided.

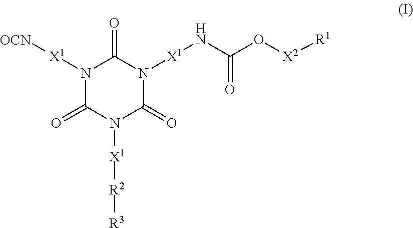

### TECHNICAL FIELD

The present disclosure broadly relates to curable compositions and methods of making and using the same.

### BACKGROUND

Curable compositions are widely used in the chemical arts for applications such as, for example, sealants and adhesives. In general, the curable composition is at least partially cured to provide a usable end product.

### SUMMARY

The present disclosure describes a dual-cure sealant system, where the primary cure mechanism is triggered by an actinic radiation source and the secondary cure mechanism is a moisture-cure reaction. Using such a dual-cure sealant system, an end user can cure the provided sealant systems with a blue-light device under most circumstances, while the secondary cure mechanism ensures that any shadowed areas, areas of abnormal thickness, etc. will still fully cure. The end user is also provided with control over work and cure times.

In one aspect, provided are curable compositions comprising a urethane multifunctional (meth)acrylate, a photo initiator system, a moisture-cure initiator, and an oligomer, where the oligomer is represented by the formula

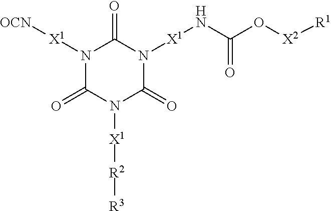

where each X¹ is independently alkylene; each X² is independently alkylene, polyether, polyester, or polyurethane; R¹ is a (meth)acrylate; R² is urethane or isocyanate; and R³ is alkylene (meth)acrylate, polyester (meth)acrylate, polyether, polyester, polyurethane, or nothing, and where the ratio of (meth)acrylate to isocyanate in the oligomer is 1:1 to 1:2.

In another aspect, provided is a method comprising applying the disclosed curable composition to a substrate and exposing the curable composition to electromagnetic radiation in the range of 340-550 nm at an intensity of 0.1-5 W/cm².

Also provided are methods of sealing a substrate and methods of adhering two substrates using curable compositions of the present disclosure.

Before any embodiments of the present disclosure are explained in detail, it is to be understood that the phraseology and terminology used herein is for the purpose of description and should not be regarded as limiting.

In this document, the terms “a,” “an,” or “the” are used to include one or more than one unless the context clearly dictates otherwise.

The term “(meth)acrylate” as used herein refers to monomers or oligomers comprising at least one (meth)acryloyloxy group having the formula CH₂═CR—(CO)—O— where R is hydrogen (i.e., acrylate) or methyl (i.e., methacrylate).

As used herein, “alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl, and the like. Unless otherwise noted, alkyl groups may be mono- or polyvalent, i.e., monovalent alkyl or polyvalent alkylene.

The term “alkoxy” as used herein refers to the group —O-alkyl, wherein “alkyl” is defined herein.

The term “aryl” as used herein refers to cyclic aromatic hydrocarbons that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons (C₆-C₁₄) or from 6 to 10 carbon atoms (C₆-C₁₀) in the ring portions of the groups.

The term “aspect ratio” as used herein refers to average particle lengths (longest dimension) divided by average particle widths. The aspect ratio is determined by measuring the length and width of a plurality of particles on an electron micrograph and dividing the average of the lengths by the average of the widths.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “0.1% to 5%” or “0.1% to 5%” should be interpreted to include not just 0.1% to 5%, but also the individual values (e.g., 1%, 2%, 3%, and 4%) and the sub-ranges (e.g., 0.1% to 0.5%, 1.1% to 2.2%, 3.3% to 4.4%) within the indicated range.

Features and advantages of the present disclosure will be further understood upon consideration of the detailed description as well as the appended claims.

### DETAILED DESCRIPTION

Curable compositions are often used in the automotive industry as sealants and protective coatings, particularly along joints or seams where two or more parts are secured together. Curing that is activated by moisture and/or heat and can have curing times that vary with composition and environmental conditions. Curing that is activated solely by light can be compromised when a sealant is applied at a thickness that does not allow actinic radiation to penetrate to a sufficient depth of the sealant layer and/or when the sealant is in a location partially or completely obscured from the curing light source. Not only does uncured material compromise the performance of a seam sealer, the resulting free acrylates also present a sensitization risk to those who come into contact with them. The present disclosure describes curable compositions that are both light and moisture curable and that give the user greater control over work and cure times, thus minimizing or eliminating the disadvantages cited above.

Provided herein are curable compositions comprising a urethane multifunctional (meth)acrylate, a photo initiator system, a moisture-cure initiator, and an oligomer, where the oligomer is represented by the formula

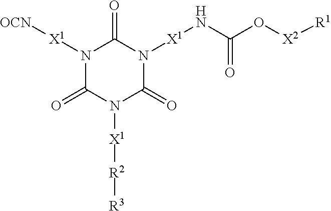

where each X¹ is independently alkylene; each X² is independently alkylene, polyether, polyester, or polyurethane; R¹ is a (meth)acrylate; R² is urethane or isocyanate; and R³ is alkylene (meth)acrylate, polyester (meth)acrylate, polyether, polyester, polyurethane, or nothing i.e., the R² group may be the terminal group in some embodiments, and where the ratio of (meth)acrylate to isocyanate in the oligomer is 1:1 to 1:2 (e.g., 1:1.5).

Suitable oligomers can be derived, for example, from the reaction product of a partially reacted hexamethylene isocyanurate with at least one hydroxy alkyl (meth)acrylate. Alternatively, suitable oligomers can be derived from the reaction product of a partially reacted hexamethylene isocyanurate with a hydroxy-terminated oligomer that contains at least one (meth)acrylate group.

Suitable oligomers for embodiments of the present disclosure include those commercially available from Allnex (Germany) under the trademark EBECRYL 4150, 4250, 4396, and 4397, and Sartomer Co., Exton, Pa. under the trade designation CN9302.

In embodiments of the present disclosure, the curable composition typically comprises 10 wt. % to 80 wt. %, 15 wt. % to 50 wt. %, or 20 wt. % to 40 wt. % of the one or more oligomers. In some preferred embodiments, the curable composition comprises 10 pbw to 70 pbw, optionally 20 pbw to 50 pbw urethane multifunctional (meth)acrylate, up to 50 pbw reactive diluent, and 10 pbw to 80 pbw, optionally 15 pbw to 50 pbw oligomer, where the sum of the polymerizable components in the curable composition is 100 pbw.

### Urethane Multifunctional (Meth)acrylates

Urethane multifunction (meth)acrylates are typically used to impart flexibility and toughness to the cured composition. Suitable urethane multifunctional (meth)acrylates for use in the curable compositions include oligomers and prepolymers comprising aliphatic urethane multifunctional (meth)acrylates and aromatic urethane multifunctional (meth)acrylates. In some embodiments, the urethane multifunctional (meth)acrylates are selected from urethane di(meth)acrylates, urethane tri(meth)acrylates, urethane tetra(meth)acrylates and combinations thereof. In some embodiments, the urethane multifunctional (meth)acrylate is a di(meth)acrylate. The term “multifunctional (meth)acrylate” as used herein means an oligomer or polymer containing two or more (meth)acryloyloxy groups.

Suitable urethane (meth)acrylates are can be made by reacting polyols with polyisocyanates to form urethane moieties and terminating the urethane moieties with multifunctional (meth)acrylates. In some embodiments, the urethane multifunctional (meth)acrylate is a urethane di(meth)acrylate comprising a carbocyclic aromatic group or a hydrocarbon group with at least four carbon atoms. In other embodiments, the urethane multifunctional (meth)acrylate is a urethane di(meth)acrylate comprising polytetramethylene oxide or polypropylene oxide. In some preferred embodiments, the urethane multifunctional (meth)acrylate comprises a polyester, a polypropylene oxide, or polytetramethylene oxide backbone. Polyethylene oxide backbones were found to be less favorable. In some embodiments, the urethane multifunctional (meth)acrylate is relatively hydrophobic.

Suitable aromatic urethane multifunctional (meth)acrylates can be derived from the reaction product of a polyol, an aromatic diisocyanate (e.g., toluene diisocyanate), and a hydroxyalkyl (meth)acrylate (e.g., hydroxyethyl (meth)acrylate and hydroxypropyl (meth)acrylate). Particularly desirable polyols include polyether polyols, polyester polyols, polylactone polyols, polysiloxane polyols, poly(alkylacrylate) polyols, and poly(glycidyl ether) polyols.

Suitable aliphatic urethane multifunctional (meth)acrylates can be derived from the reaction product of polyether polyols (e.g., hydroxyl terminated polypropylene oxide or hydroxyl terminated polytetramethylene oxide), aliphatic diisocyanates (e.g., isophorone diisocyanate), and a hydroxyalkyl (meth)acrylate (e.g., hydroxylethyl (meth)acrylate or hydroxypropyl (meth)acrylate). Suitable aliphatic urethane multifunctional (meth)acrylates also include an aliphatic urethane multifunctional (meth)acrylate having a polycaprolactone backbone. For example, a hydroxylethyl (meth)acrylate ring opens the caprolactone forming a mono-alcohol that is reacted with isophorone diisocyanate, resulting hydrophobic aliphatic urethane di(meth)acrylate.

Commercially available urethane multifunctional (meth)acrylates include those from Allnex (Germany) under the trademark EBECRYL and designations 244, 264, 265, 1290, 4833, 4883, 8210, 8311, 8402, 8405, 8807, 5129, and 8411; those available from Sartomer under the designations, CN 973H85, CN 985B88, CN 964, CN 944B85, CN 963B80, CN 973J75, CN 973H85, CN 929, CN 996, CN 966J75, CN 968, CN 980, CN 981, CN 982B88, CN 982B90, CN 983, CN991, CN 2920, CN 2921, CN 2922, CN 9001, CN 9005, CN 9006, CN 9007, CN 9009, CN 9010, CN 9031, CN 9782; GENOMER 4212, 4215, 4217, 4230, 4256, 4267, 4269, 4302, and 4316 and UA 00-022 available from Rahn; PHOTOMER 6892 and 6008 available from Cognis; and NK OLIGO U24A and U-15HA available from Kowa. Additional urethane multifunctional (meth)acrylates include the BR series of aliphatic urethane (meth)acrylates such as BR 144 or 970 available from Bomar Specialties or the LAROMER series of aliphatic urethane (meth)acrylates such as LAROMER LR 8987 from BASF.

Commercially available urethane multifunctional (meth)acrylates for use in the curable compositions include those known by the trade designations: PHOTOMER (for example, PHOTOMER 6010 from Henkel Corp., Hoboken, N.J.); EBECRYL (for example, EBECRYL 220 (a hexafunctional aromatic urethane acrylate of molecular weight 1000), EBECRYL 284 (aliphatic urethane diacrylate of 1200 grams/mole molecular weight diluted with 1,6-hexanediol diacrylate), EBECRYL 4827 (aromatic urethane diacrylate of 1600 grams/mole molecular weight), EBECRYL 4830 (aliphatic urethane diacrylate of 1200 grams/mole molecular weight diluted with tetraethylene glycol diacrylate), EBECRYL 6602 (trifunctional aromatic urethane acrylate of 1300 grams/mole molecular weight diluted with trimethylolpropane ethoxy triacrylate), and EBECRYL 840 (aliphatic urethane diacrylate of 1000 grams/mole molecular weight)) from Allnex (Germany); SARTOMER (for example, SARTOMER 9635, 9645, 9655, 963-B80, and 966-A80) from Sartomer Co., West Chester, Pa.; and UVITHANE (for example, UVITHANE 782) from Morton International, Chicago, Ill.

Commercially available aliphatic urethane multifunctional (meth)acrylates include those available from Soltech Ltd., Kyoungnam, Korea, such as SU 500 (aliphatic urethane diacrylate with isobornyl acrylate), SU 5020 (hexa-functional aliphatic urethane acrylate oligomer with 26% butyl acetate), SU 5030 (hexa-functional aliphatic urethane acrylate oligomer with 31% butyl acetate), SU 5039 (nona(9)-functional aliphatic urethane acrylate oligomer), SU 511 (aliphatic urethane diacrylate), SU 512 (aliphatic urethane diacrylate), SU 514 (aliphatic urethane diacrylate with hexane diol diacrylate (HDDA)), SU 591 (aliphatic urethane triacrylate with N-(2-hydroxypropyl) methacrylamide), SU 520 (deca(10)-functional aliphatic urethane acrylate), SU 522 (hexa-functional aliphatic urethane acrylate), SU 5225 (aliphatic urethane diacrylate with isobornyl acrylate), SU 522B (hexa-functional aliphatic urethane acrylate), SU 5260 (aliphatic urethane triacrylate), SU 5270 (aliphatic urethane diacrylate), SU 530 (aliphatic urethane diacrylate), SU 5347 (aliphatic urethane diacrylate), SU 542 (low viscosity aliphatic urethane diacrylate), SU 543 (low viscosity aliphatic urethane diacrylate), SU 564 (aliphatic urethane triacrylate with HDDA), SU 565 (aliphatic urethane triacrylate with tripropylene glycol diacrylate), SU 570 (aliphatic urethane diacrylate), SU 571 (hexa functional aliphatic urethane diacrylate), SU 574 (aliphatic urethane triacrylate with HDDA), SU 574B (aliphatic urethane triacrylate with HDDA), SU 580 (aliphatic urethane diacrylate), SU 584 (aliphatic urethane triacrylate with HDDA), SU 588 (aliphatic urethane triacrylate with 2-(2-ethoxyethoxy)ethyl acrylate), and SU 594 (aliphatic urethane triacrylate with HDDA).

Commercially available aromatic urethane multifunctional (meth)acrylates include those available from Soltech Ltd., Kyoungnam, Korea, such as SU 704 (aromatic urethane triacrylate with HDDA), SU 710 (aromatic urethane diacrylate), SU 720 (hexa-functional aromatic urethane acrylate), and SU 7206 (aromatic urethane triacrylate with trimethylolpropane triacrylate).

In some embodiments, the urethane multifunction (meth)acrylate has a number average molecular weight of 900-20,000 Daltons (grams/mole) as measure using Gel Permeation Chromatography. If the number average molecular weight is less than 900 Daltons, the cured material tends to be brittle, leading to low T-peel strength. If the number average molecular weight is greater than 20,000 Daltons, however, the viscosity of the polymerizable composition may be too high. In some embodiments, the urethane multifunction (meth)acrylate has a number average molecular weight of 3,000-20,000 Daltons or 5,000 to 20,000 Daltons as measured using Gel Permeation Chromatography.

In some embodiments, the curable composition comprises 10 wt. % to 70 wt. %, 15 wt. % to 50 wt. %, or 20 wt. % to 40 wt. %, of one or more urethane multifunctional (meth)acrylates.

### Photoinitiator Systems

The photoinitiator systems comprise a photoinitiator and optional photosensitizer. Suitable photoinitiators can be activated by electromagnetic radiation in the 340-550 nm range and have an extinction coefficient of from 10 to 2000 L/mol·cm (e.g., 50 to 500 L/mol·cm or 100 to 700 L/mol·cm) at a wavelength from 340-550 nm. Alternatively, photoinitiators can be used in combination with photosensitizers that absorb at wavelengths above 340 nm and excite the photoinitiator through energy transfer. In some embodiments, the composition upon curing has a depth of cure of at least 5 mm after electromagnetic radiation exposure in the range of 400 to 500 nm at an intensity of 2 W/cm² for 5 seconds.

Suitable photoinitiators include quinones, coumarins, phosphine oxides, phosphinates, mixtures thereof and the like. Commercially available photoinitiators include camphorquinone (CPQ), phosphine oxides such as LUCIRIN TPO, LUCIRIN TPO-L, LUCIRIN TPO-XL available from BASF or IRGACURE 819, IRGACURE 2100 available from Ciba, and phosphine oxides available from IGM Resins USA Inc. under the OMNIRAD trade designation such ethyl-2,4,6-trimethylbenzoylphenyl phosphinate (e.g., available as OMNIRAD TPO-L), 2,4,6-trimethylbenzoyl-diphenyl-phosphine oxide (e.g., available as OMNIRAD TPO), and bis-(2,4,6-trimethylbenzoyl)-phenylphosphine oxide (e.g., available as OMNIRAD 819). In some embodiments, the photoinitiator is

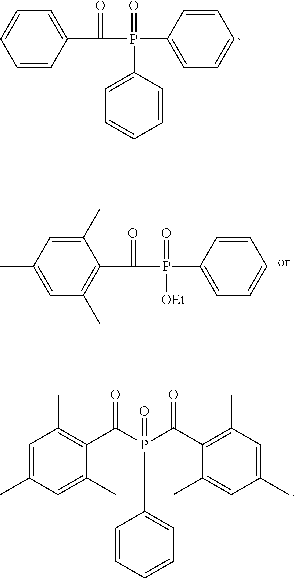

In some embodiments, the curable composition comprises less than 5 wt. %, more particularly 2-3 wt. % of one or more photoinitiators.

Examples of suitable photosensitizers include, for example, camphorquinone, coumarin photosensitizers such as (7-ethoxy-4-methylcoumarin-3-yl)phenyliodonium hexafluoroantimonate, (7-ethoxy-4-methylcoumarin-6-yl)]phenyliodonium hexafluoroantimonate, (7-ethoxy-4-methylcoumarin-3-yl)phenyliodonium hexafluorophosphate, (7-ethoxy-4-methylcoumarin-6-yl)]phenyliodonium hexafluorophosphate, such as those described in Ortyl and Popielarz, Polimery 57: 510-517 (2012); 1,3-dioxane methyl coumarin, such as is described in Yin et al., Journal of Applied Polymer Science 125: 2371-2371 (2012); coumarin dye; and ketocoumarin dye. Other examples of suitable photosensitizers and accelerators are described, for example, in U.S. Pub. No 2019/0000721 (Ludsteck et al.) and U.S. Pat No. 8,501,834 (Maletz et al.), the contents of which are incorporated herein in their entireties. In some embodiments, the curable composition comprises 0.0001 wt. % to 5 wt. % of one or more photosensitizers.

### Moisture-Cure Initiators

Metallic catalysts useful as moisture-cure initiators in embodiments of the present disclosure include, for example, dibutyl tin dilaurate, dibutyl tin diacetate, dibutyl tin bis(acetylacetonate), dibutyl tin dicarboxylates, and similar tin compounds; stannous octoate, stannous acetate, and similar stannous compounds; metal catalysts containing bismuth, zinc, zirconium, and titanium; tertiary amines such as, for example, dimorpholinodiethyl ether, N,N-dimethylaminoethanol, N-ethylmorpholine, N,N-dimethyl-cyclohexamine-bis(2-dimethyl aminoethyl)ether, diazabicyclooctane, dimethylpiperazine, triethylene diamine; and combinations thereof.

In some preferred embodiments, the curable composition comprises up to 5 wt. %, 0.01 wt. % to 2 wt. %, or 0.1 wt. % to 1 wt. % of one or more moisture-cure initiators.

Reactive Diluent

Suitable reactive diluents for use in the compositions include one or more monomers that have a single ethylenically unsaturated group that is typically miscible with the urethane multifunctional (meth)acrylate. Mono (meth)acrylates can reduce crosslinking density so that the cured composition is elastomeric. Examples of mono (meth)acrylates include benzyl methacrylate, isooctyl acrylate (e.g., commercially available as SR-440 from Sartomer, Exton, Pa.), isodecyl acrylate (e.g., commercially available as SR-395 from Sartomer), isobornyl acrylate (e.g., commercially available as SR-506 from Sartomer), 2-phenoxyethyl acrylate (e.g., commercially available as SR-339 from Sartomer), alkoxylated tetrahydrofurfuryl acrylate (e.g., commercially available as CD-611 from Sartomer), 2(2-ethoxyethoxy)ethylacrylate (e.g., commercially available as SR-256 from Sartomer), ethoxylated nonylphenol acrylate (e.g., commercially available as SR-504 from Sartomer), propoxylated tetrahydrofurfuryl acrylate (e.g., commercially available as SR-611 from Sartomer), 2-phenoxyethyl methacrylate (e.g., commercially available as SR-340 from Sartomer), tetrahydrofurfuryl methacrylate (e.g., commercially available as SR-203 from Sartomer), alkoxylated phenol acrylate monomer (e.g., commercially available as SR-9087 from Sartomer), p-cumyl phenoxyethyl acrylate (commercially available as CD590 from Sartomer), 2-hydroxy-3-phenoxypropyl acrylate (commercially available as CN3100 from Sartomer), acrylic oligomer (commercially available as CN 2285 from Sartomer), phenol (EO)2 acrylate (commercially available as MIRAMER M142 from Miwon), Nonyl phenol (PO)2 acrylate (commercially available as MIRAMER M1602 from Miwon), o-phenylphenol EO acrylate (commercially available as MIRAMER M1142 from Miwon) Other reactive diluent monomers include, for example, methyl styrene, styrene, divinyl benzene, and the like.

Other suitable reactive diluents comprise monomers with a single ethylenically unsaturated group having a urethane linkage (—NH—(CO)—O—), such as urethane (meth)acrylates and 2-[[(butylamino)carbonyl]oxy]ethyl acrylate, which is commercially available under the trade designation GENOMER G1122 from Rahn USA Corp. in Aurora, Ill.

Suitable reactive diluents typically do not include monomers having ethylenically unsaturated groups containing an ionic group, such as an acidic group or an amino group or monomers having ethylenically unsaturated groups containing a hydroxyl group.

In some embodiments, the curable composition can comprise up to 50 wt. %, more particularly 20 wt. % to 40 wt. % of one or more reactive diluents.

Preferably, the curable compositions comprise low volatile organics (“VOC”). Such compositions are good for the environment and reduce potential odors generated by the curing process. In preferred embodiments, the reactive diluent has a vapor pressure less than 0.1 Pa at 25° C., more particularly less than 0.01 Pa, and even more particularly less than 0.001 Pa. Such diluents are less likely to be volatized during the curing process. In some embodiment, the diluent comprises a mono(meth)acrylate.

### Corrosion Inhibitor

Examples of suitable corrosion inhibitors include, for example, primary, secondary and tertiary aliphatic amines; aliphatic diamines; cycloaliphatic and aromatic amines; polymethylimines; long alkyl chain ethanolamines; imidazolines; amine-epoxy adduct solids, such as FUJICURE FXR-1020, ANCAMINE® 2442, FUJICURE FXR-1080, amine salts of an aromatic sulfonic acid, NACORR® 1754, for example those of carbonic, carbamic, acetic, benzoic, oleic, nitrous and chromic acids; acetylenic alcohols; lauric alcohol; alkyl chromates; organic esters of nitrous acid; organic esters of phthalic acid; organic esters of carbonic acid; nitronaphthalene; nitrobenzene; amides; mixtures of nitrites with urea, urotropine, or ethanolamines; naphthols; thiourea derivatives; heterocyclic compounds such as benzotriazole, triazoles, mercaptobenzothiazole and their respective salts; nitrated or sulfonated petroleum derivatives; and zinc phosphate complex LUBRIZOL® 219, dodecenyl succinic acid LUBRIZOL® 541. In some embodiments, the corrosion inhibitor comprises at least one of a triazole, an imidazoline, an amine, a zinc phosphate complex and dodecenyl succinic acid. In some embodiments, the curable compositions typically comprise less than 5 wt. % of one or more corrosion inhibitors.

### Photobleachable Dyes/Agents

In some embodiments, it may be desirable to have a visual indication of the progress of curing of the curable composition as the result of exposure to actinic radiation. Such progress can be monitored, for example, by inclusion of photobleachable dyes/agents in the curable composition. Suitable photobleachable dyes/agents include, for example, aminoanthraquinone dyes, azo dyes, and combinations thereof. Additional exemplary photobleachable dyes/agents include, Rose Bengal, Methylene Violet, Methylene Blue, Fluorescein, Eosin Yellow, 65 Eosin Y, Ethyl Eosin, Eosin bluish, Eosin B, Erythrosin B, Erythrosin Yellowish Blend, Toluidine Blue, Disperse blue 60, oil blue A, 4′,5′-Dibromofluorescein, monoamine anthraquinone, diaminoanthraquinone, and blends thereof. In some embodiments, the curable composition comprises 0.0001 wt. % to 5 wt. % of one or more photobleaching dyes/agents.

### Other Components

Other components that may be optionally added to the disclosed curable composition include, for example, a silica, a filler, a stabilizer, and combinations thereof.

Silica

Reinforcing silica can be used as a viscosity and thixotropy modifier. In some embodiments, the viscosity of the curable composition is 5-1,000 PaS. For example, the silica may be added in amounts to achieve a viscosity such that the composition is self-wetting, i.e. freely flowing on the surface of the substrate and filling voids. The silica may be added in amounts such that the composition is sprayable. Finally, the silica may be added in amounts such that the composition forms a caulk for filling spaces, voids or interstices of substrates.

Suitable reinforcing silicas typically have a primary particle dimension no greater than 100 nm and, therefore, have little to no effect on the penetration of light within the composition during curing. As used herein, the term “primary particle” means a particle in unaggregated form, although the primary particle may be combined with other primary particles to form aggregates on the micron size scale. Reinforcing silicas include fused or fumed silicas and may be untreated or treated so as to alter the chemical nature of their surface. Examples of treated fumed silicas include polydimethylsiloxane-treated silicas, hexamethyldisilazane-treated silicas and silicas that are surface treated with alkyltrimethoxysilanes, such as hexyl (C6), octyl (C8), decyl (C10), hexadecyl (C16), and octadecyl(C18)trimethoxysilanes. Commercially available treated silicas are available from Cabot Corporation under the tradename CAB-O-SIL ND-TS, such as CAB-O-SIL TS 720, 710, 610, 530, and Degussa Corporation under the tradename AEROSIL, such as AEROSIL R805.

Of the untreated silicas, amorphous and hydrous silicas may be used. Commercially available amorphous silicas include AEROSIL 300 with an average particle size of the primary particles of about 7 nm, AEROSIL 200 with an average particle size of the primary particles of about 12 nm, AEROSIL 130 with an average size of the primary particles of about 16 nm. Commercially available hydrous silicas include NIPSIL E150 with an average particle size of 4.5 nm, NIPSIL E200A with and average particle size of 2.0 nm, and NIPSIL E220A with an average particle size of 1.0 nm (manufactured by Japan Silica Kogya Inc.).

In some embodiments, the curable composition comprises 1-10 wt. % of one or more reinforcing silicas.

Fillers

The inorganic filler, when present, is chosen to minimize interference with the light curing process. The filler particles or fibers are of sufficient size that a mismatch in the refractive index between the filler and curing resin could reduce the penetration of light into the curable composition and render the depth of cure insufficient for the intended application. Therefore, to minimize the effects of light scatter by the filler and to insure sufficient depth of curing, the sum of the absolute value of the difference in the refractive index of the filler and the refractive index of the composition cured without filler plus the birefringence of the filler is 0.054 or less, i.e.

0.054≥|n_{filler}−nₘₐₜᵣᵢₓ|+δ_{filler},
where
n_{filler} is the refractive index of the filler,
nₘₐₜᵣᵢₓ is the refractive index of the composition cured without filler, and
δ_{filler} is the birefringence of the filler.

The inorganic fillers can improve impact resistance and increase hardness. Additionally, the inorganic fillers can reduce the amount of diluent used in the curable composition. Many suitable diluents are volatile organic compounds (VOCs) that can not only have a negative impact on the environment but can also generate unwanted odors as the diluent is vaporized by the heat generated during the curing process. The inorganic fillers can reduce the amount of diluent when contrasted with the curable composition without the filler. Additionally, the filler can act as a heat sink to reduce the temperature of the curing composition, which in turn reduces or eliminates volatilization of the diluent.

It is preferable to use inorganic fillers that reduce or minimize the effects of light scattering in order to insure sufficient depth of curing. Therefore, inorganic fillers of the present disclosure are selected such that the sum of the absolute value of the difference in the refractive index of the filler and the refractive index of the composition cured without filler plus the birefringence of the filler is 0.054 or less.

In some embodiments, the inorganic filler has a higher refractive index than the organic phase of the curable composition (i.e. everything but the inorganic filler). In some embodiments, the refractive index of the inorganic filler is between the refractive indices of the organic phases of the uncured and cured compositions. More particularly, in some embodiments, the refractive index of the inorganic filler is midway between the refractive indices of the organic phases of the uncured and the cured compositions.

In some embodiments, the inorganic filler may have a refractive index of at least 1.490, 1.500, 1.510, 1.520, 1.530, or 1.540, the organic phase of the curable composition may have a refractive index of 1.460, 1.470, 1.480, 1.490, 1.500, 1.510, and the cured organic phase of the composition may have a refractive index of 1.480, 1.490, 1.500, 1.510, 1.520, 1.530. In some preferred embodiments, the cured organic phase of the composition may have a refractive index of 1.500 to 1.530. As curing proceeds, the curable composition typically becomes more and more translucent, enabling higher depth of cure.

Fillers may be either particulate or fibrous in nature. Particulate fillers may generally be defined as having a length to width ratio, or aspect ratio, of 20:1 or less, and more commonly 10:1 or less. Fibers can be defined as having aspect ratios greater than 20:1, or more commonly greater than 100:1. The shape of the particles can vary, ranging from spherical to ellipsoidal, or more planar such as flakes or discs. The macroscopic properties can be highly dependent on the shape of the filler particles, in particular the uniformity of the shape.

Suitable inorganic fillers have at least one dimension greater than 200 nm. For example, in the case of spherical fillers, the diameter of the particles is at least 200 nm. In the case of fibers, the length (longest dimension) of a fiber is at least 200 nm.

Exemplary inorganic fillers include inorganic metal oxides, inorganic metal hydroxides, inorganic metal carbides, inorganic metal nitrides such as ceramics, and various glass compositions (e.g., borate glasses, phosphate glasses, and fluoroaluminosilicate). More particularly, inorganic fillers include alumina trihydrate, alumina, silica, silicate, beryllia, zirconia, magnesium oxide, calcium oxide, zinc oxide, titanium dioxide, aluminum titanate, silicon carbide, silicon nitride, aluminum nitride, titanium nitride, aluminum trihydrate, and magnesium hydroxide.

Commercially available inorganic fillers include 3M CERAMIC MICROSPHERE WHITE GRADES W-210, W-410 and W-610 from 3M Company (St. Paul, Minn.), MINEX brand micronized functional fillers such as MINEX 3 Nepheline Syenite, MINEX 7 Nepheline Syenite and MINEX 10 Nepheline Syenite from Carry Company (Addison, Ill.), Schott dental glass type GM27884 from Schott (Southbridge, Mass.), DRAGONITE-XR halloysite clay from Applied Minerals (New York, N.Y.). In preferred embodiments, the filler is uniformly distributed throughout the curable composition and does not separate from the polymerizable composition before or during curing.

In some embodiments, the curable composition comprises up to 40 wt. % (e.g., 5 of one or more inorganic fillers. Compositions comprising less than 5 wt. % of inorganic filler typically require a higher amount of diluent (e.g., volatile organic compounds) and reduce the potential heat sink effect mentioned above. Compositions comprising greater than 50 wt. % inorganic filler can diminish cure depth.

Stabilizer

In some embodiments, it may be desirable to include 0.01 wt. % to 1 wt. % of a radical stabilizer in the curable composition. Suitable stabilizers are known in the art and available, for example, under the trade name PROSTAB 5198 from BASF, Ludwigshafen, Germany.

Crosslinking Agent

In some embodiments, the curable composition may optionally include a multifunctional (meth)acrylate crosslinking agent. Exemplary agents include trimethylolpropane trimethacrylate (e.g., SR350 from Sartomer), trimethylolpropane triacrylate (e.g , SR351 from Sartomer), 1,6-hexanediol di(meth)acrylate (e.g., HDDA from UCB Radcure, Inc. of Smyrna, Ga.), tripropylene glycol di(meth)acrylate, polyethylene glycol di(meth)acrylate (e.g., Sartomer 344), tripropylene glycol di(meth)acrylate, neopentyl glycol dialkoxy di(meth)acrylate, polyethyleneglycol di(meth)acrylate, 1,3-butylene glycol diacrylate (e.g., commercially available as SR-212 from Sartomer), 1,6-hexanediol diacrylate (e.g., commercially available as SR-238 from Sartomer), neopentyl glycol diacrylate (e.g., commercially available as SR-247 from Sartomer), and diethylene glycol diacrylate (e.g., commercially available as SR-230 from Sartomer). Crosslinking agents preferably do not contain urethane functional groups. (meth)acrylate crosslinker based on 100 pbw of the total polymerizable components of the composition.

In some embodiments, the curable composition comprises 0.1-10 wt % of one or more crosslinking agents. Higher amounts of crosslinking agent can diminish the elasticity of the curable composition, making it less flexible for sealant applications.

As used herein, the term “low molecular weight multifunctional (meth)acrylate crosslinker” refers to a multifunctional (meth)acrylate crosslinker as defined above, where the molecular weight of the crosslinker is less than or equal to 1000 g/mol. In some embodiments, the curable composition includes 0.1 pbw to 10 pbw low molecular weight multifunctional crosslinker.

Other components that may be optionally added to the disclosed curable composition include, for example, pigments, surfactants, thixotropic agents, fire retardants, masking agents, and combinations of any of the foregoing. In some embodiments, glass fibers (e.g., glass clothe, fiberglass matt, chopped fiberglass) can be added to create a cured composite that can be used in car repair applications. In some embodiments, the curable compositions comprise up to 20 wt. % of one or more additional components.

Curable compositions according to the present disclosure are useful, for example, for sealing a substrate and/or adhering two substrates. To seal a substrate, including gap filling between bonded components in an electronic device, a curable composition according to the present disclosure may be applied to a surface of the substrate. Any suitable method of application may be used including, for example, dispensing from a nozzle (e.g., a mixing nozzle). Once applied, the curable composition is at least partially cured by exposure to a light source such as, for example, a 3M Blue Light Gun (450 nm LED source, 3M Company, Saint Paul, Minn.) for example, for at least 5 seconds, at least 10 seconds, or at least 15 seconds with the source at a distance of, for example, about 1 cm, 2 cm, or 3 cm from the sample. While time is generally sufficient to cause curing at room temperature, optional heating may be applied to accelerate curing.

Exemplary substrates may include, metal (e.g., steel), polymer, glass, ceramic, and combinations thereof. Particular examples include electronic component assemblies, automotive articles, and aviation/aerospace components.

The curable composition may also be used to adhere two substrates. To adhere two substrates, a curable composition according to the present disclosure may be applied to a surface of a first substrate. Any suitable method of application may be used including, for example, dispensing from a nozzle (e.g., a mixing nozzle). Next, a second surface of a second substrate is contacted with the curable composition, and the curable composition is at least partially cured by exposure to a light source such as, for example, a 3M Blue Light Gun (450 nm LED source, 3M Company, Saint Paul, Minn.) for at least 5 seconds, at least 10 seconds, or at least 15 seconds with the source at a distance of about 1 cm, 2 cm, or 3 cm from the sample. While time is generally sufficient to cause curing at room temperature, optional heating may be applied to accelerate curing.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight. All chemicals were purchased from the given suppliers and used as received.

TABLE 1
Materials

| Name | Source | Role |
|---|---|---|
| OMNIRAD 819 | IGM, Charlotte, NC | Photo initiator |
| CAB-O-SIL TS-720 | Cabot Corp., Boston, MA | Filler |
| Benzotriazole | PMC Specialties, Cincinnati, OH | Corrosion inhibitor |
| SR350 | Sartomer Co., Exton, PA | Crosslinker |
| PROSTAB 5198 | BASF, Ludwigshafen, Germany | Radical stabilizer |
| Disperse blue 60 | Sigma-Aldrich, St. Louis, MO | Photobleaching dye |
| Dibutyltin Dilaurate | Alfa Aesar, Haverhill, MA | Catalyst |
| CN973H85 | Sartomer Co., Exton, PA | Polyurethane crosslinker |
| GENOMER 4230 (G4230) | Rahn USA Corp., Aurora, IL | Polyurethane crosslinker |
| MIRAMER M1142 | Miwon Specialty Chemical Co., | Monomeric Diluent |
| (M1142) | Exton, PA | |
| GENOMER 1122 (G1122) | Rahn USA Corp., Aurora, IL | Monomeric Diluent |
| MIRAMER M142 (M142) | Miwon Specialty Chemical Co., | Monomeric Diluent |
| | Exton, PA | |
| CN9302 | Sartomer Co., Exton, PA | Isocyanate |
| EBECRYL4150 (E4150) | Allnex, Frankfurt, Germany | Isocyanate |
| EBECRYL 4250 (E4250) | Allnex, Frankfurt, Germany | Isocyanate |
| EBECRYL 4396 (E4396) | Allnex, Frankfurt, Germany | Isocyanate |
| EBECRYL 4397 (E4397) | Allnex, Frankfurt, Germany | Isocyanate |
| DESMODUR E 21 (DE 21) | Allnex, Frankfurt, Germany | Isocyanate |

### Test Methods

T-Peel Adhesion Test

Freshly abraded 3×0.3 inch steel t-peel substrates were rinsed with isopropanol and allowed to air dry. A seam sealer mixture was applied to the abraded surface of one substrate at a thickness of 3 mm, and then covered with a second substrate to form the t-peel sample. After removing excess seam sealer from the edges, the sample was cured using a 3M Blue Light Gun (450 nm LED source, 3M Company, Saint Paul, Minn.) for 30 seconds on each long edge, and 5 seconds on the short edges. To moisture cure, the radiation-cured samples were placed in a desiccator with a shallow dish of water for at least 72 hours. The T-peel adhesion tests were done on an Instron 3342 tester (Instron, Norwood, Mass.) at 2.0 inch/min speed to obtain average peel strength and peak load. Samples were repeated in triplicate.

Corrosion Resistance Test

Accelerated corrosion tests were performed following the ASTM B117 procedure. Freshly abraded cold-rolled steel panels were rinsed with isopropanol and air-dried. A seam sealer was then applied at a thickness of 50 mils to an area of approximately 3.5×3.5 inches and cured from the top using a 3M Blue Light Gun (450 nm LED source, 3M Company, Saint Paul, Minn.) for 1 minute. The edges of the applied seam sealer and the panel were then sealed with a 2K epoxy resin. The panels were placed in a salt fog chamber (5 wt % NaCl and air-sparging) for three weeks. Samples were repeated in triplicate. Once the test was completed, the panels were removed, rinsed and dried, and evaluated for corrosion by direct inspection.

### General Procedure for Preparing Formulations

Stock solutions were prepared by combining the monomeric diluent, OMNIRAD 819, benzotriazole, PROSTAB 5198, and disperse blue in an amber glass jar and that was then rolled under a heat lamp until all the solids dissolved. Once cool, the appropriate amount of stock solution was weighed into a speed mixer jar, followed by the remaining reagents. The mixture was then homogenized using a FlackTek DAC 400.2 Vac speed mixer: 3 cycles of 2 minutes at 1000 rpm without vacuum, followed by one cycle of 2.5 minutes at 1500 rpm and 30 torr. The formulations were stored at ambient conditions in speed mixer jars covered in aluminum foil.

TABLE 2
General Formulation of Comparative Examples
(Not Including Moisture Cure Catalyst)

| Reagent | Amount (g) | Wt. % |
|---|---|---|
| Polyurethane crosslinker | 30 | 25.5 |
| Monomeric diluent | 40 | 34 |
| Isocyanate | 30 | 25.5 |
| OMNIRAD 819 | 5 | 4.25 |
| CAB-O-SIL TS-720 | 6.5 | 5.53 |
| Benzotriazole | 2 | 1.7 |
| SR350 | 4 | 3.4 |
| PROSTAB 5198 | 0.1 | 0.08 |
| Disperse blue 60 | 0.0008 | 0.00068 |

TABLE 3
Comparative Examples

| Comparative | | Monomeric | Polyurethane | Maximum | Peel force | Corrosion |
|---|---|---|---|---|---|---|
| Example | Isocyanate | Diluent | Crosslinker | Force (N) | (N/mm) | Resistance |
| A | CN9302 | M1142 | CN973H85 | 50.95 ± 9.57 | 4.39 ± 0.04 | PASS |
| B | E4150 | M1142 | CN973H85 | 63.73 ± 2.47 | 5.29 ± 0.32 | PASS |
| C | E4250 | M1142 | CN973H85 | 44.26 ± 3.54 | 2.80 ± 0.13 | PASS |
| D | E4396 | Ml 142 | CN973H85 | 41.97 ± 3.10 | 1.70 ± 0.26 | PASS |
| E | E4397 | Ml 142 | CN973H85 | 41.58 ± 4.58 | 2.82 ± 0.03 | PASS |
| F | CN9302 | M142 | G4230 | 42.99 ± 6.53 | 2.08 ± 0.17 | PASS |
| G | E4150 | M142 | G4230 | 51.19 ± 7.76 | 2.98 ± 0.06 | PASS |
| H | CN9302 | G1122 | G4230 | 35.30 ± 4.52 | 2.12 ± 0.04 | low PASS |
| I | E4150 | GH22 | G4230 | 44.62 ± 5.65 | 3.23 ± 0.09 | low PASS |
| J | DE 21 | M1142 | G4230 | 54.68 ± 7.63 | 3.52 ± 0.52 | PASS |
| K | CN9302 | M142 | G4230 | 18.68 ± 5.33 | 1.44 ± 0.28 | PASS |
| L | E4150 | M142 | G4230 | 22.04 ± 4.65 | 1.91 ± 0.30 | PASS |
| M | DE 21 | M142 | G4230 | 30.17 ± 4.87 | 2.07 ± 0.26 | PASS |

TABLE 4
General Formulation of Examples
(Including Moisture Cure Catalyst)

| Reagent | Amount (g) | Wt % |
|---|---|---|
| Polyurethane crosslinker | 30 | 25.5 |
| Monomeric diluent | 40 | 34 |
| Isocyanate | 30 | 25.5 |
| OMNIRAD 819 | 5 | 4.25 |
| CAB-O-SIL TS-720 | 6.5 | 5.53 |
| Benzotriazole | 2 | 1.7 |
| SR350 | 4 | 3.4 |
| PROSTAB 5198 | 0.1 | 0.08 |
| Disperse blue 60 | 0.0008 | 0.00068 |
| Dibutyltin Dilaurate | 0.1 | 0.08 |

TABLE 5
Examples

| | | Monomeric | Polymethane | Maximum | Peel force | Corrosion |
|---|---|---|---|---|---|---|
| Example | Isocyanate | Diluent | Crosslinker | force (N) | (N/mm) | Resistance |
| 1 | E4150 | M1142 | CN973H85 | 45.02 ± 3.73 | 4.24 ± 0.44 | PASS |
| 2 | E4150 | M1142 | G4230 | 44.73 ± 4.78 | 2.77 ± 0.07 | PASS |
| 3 | E4150 | GH22 | G4230 | 36.88 ± 6.38 | 2.22 ± 0.14 | PASS |
| 4 | DE 21 | M1142 | G4230 | 56.52 ± 0.48 | 4.34 ± 0.15 | PASS |

TABLE 6
Radiation Cure Characteristics of Select Comparative Examples

| | | | | Cure | Cure |
|---|---|---|---|---|---|
| | | Monomeric | Polyurethane | Depth | speed |
| Example | Isocyanate | Diluent | Crosslinker | (mm)^{a} | (s)^{b} |
| A | CN9302 | M1142 | CN973H85 | 10.5 | 15 |
| B | E4150 | M1142 | CN973H85 | 10 | 15 |
| F | CN9302 | M1142 | G4230 | 8 | 15 |
| G | E4150 | M1142 | G4230 | 9 | 15 |
| H | CN9302 | G1122 | G4230 | 11 | 7 |
| I | E4150 | G1122 | G4230 | 11 | 5 |
| K | CN9302 | M142 | G4230 | 10 | 7 |
| L | E4150 | M142 | G4230 | 12.5 | 7 |

^{a}15 second light exposure, 1 inch from surface; measured at the center of the sample
^{b}15 × 10 × 3 mm sample, time to fully cure sample from center to edges; light source 1 inch from surface

### Moisture Cure Properties

Samples were placed in aluminum pans protected from light and observed at regular intervals for up to several weeks at ambient conditions. Formulations with aliphatic isocyanates showed negligible curing activity under these conditions without the addition of catalyst. Formulations with 0.1 wt % dibutyltin dilaurate (Table 5) formed a skin on the material after about 24 hours. Formulations with higher levels of dibutyltin dilaurate (about 0.5 wt %) skinned over and/or foamed within several hours. The moisture cure resulted in a higher viscosity liquid or granular solid. Formulations containing Desmodur E 21 skinned over under ambient conditions after approximately 1 hour even without the addition of catalyst.

All cited references, patents, and patent applications in the above application for letters patent are herein incorporated by reference in their entirety in a consistent manner In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A curable composition comprising:
a urethane multifunctional (meth)acrylate;
a photo initiator system;
a moisture-cure initiator; and
an oligomer,
wherein the oligomer is represented by the formula 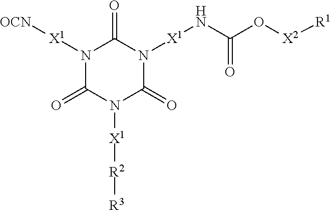
wherein
each X¹ is independently alkylene;
each X² is independently alkylene, polyether, polyester, or polyurethane;
R¹ is a (meth)acrylate;
R² is urethane or isocyanate; and
R³ is alkylene (meth)acrylate, polyester (meth)acrylate, polyether, polyester, polyurethane, or nothing, and
wherein the ratio of (meth)acrylate to isocyanate in the oligomer is 1:1 to 1:2.

2. The curable composition of claim 1, further comprising a reactive diluent.

3. The curable composition of claim 2 comprising:
10 pbw to 70 pbw urethane multifunctional (meth)acrylate;
up to 50 pbw reactive diluent; and
10 pbw to 80 pbw oligomer;
wherein the sum of the polymerizable components in the curable composition is 100 pbw.

4. The curable composition of claim 3 comprising 20 to 40 wt. % reactive diluent.

5. (canceled)

6. The curable composition of claim 1, wherein the photoinitiator system has an extinction coefficient of from about 10 to about 2000 L/mol·cm at a wavelength from about 400 nm to about 500 nm.

7. The composition of claim 1, wherein the photoinitiator system comprises

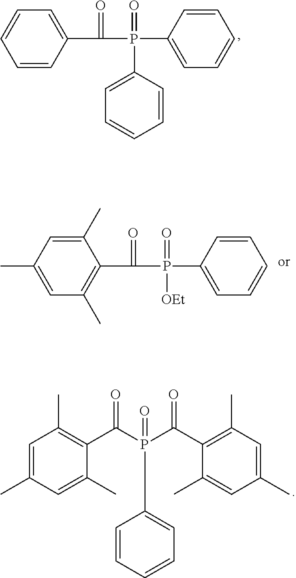

8. The curable composition of claim 1 comprising less than 5 wt. % of the moisture-cure initiator.

9. The curable composition of claim 1, wherein the moisture-cure initiator comprises dibutyltin dilaurate.

10. (canceled)

11. The curable composition of claim 1, wherein the composition further comprises up to 5 wt. % of a corrosion inhibitor.

12. The curable composition of claim 1, further comprising a photobleachable dye.

13. The curable composition of claim 1, further comprising a low molecular weight multifunctional (meth)acrylate crosslinker.

14. The curable composition of claim 13, comprising 0.1 pbw to about 10 pbw low molecular weight multifunctional (meth)acrylate crosslinker based on 100 pbw of the total polymerizable components of the composition.

15. The curable composition of claim 1 further comprising a radical stabilizer.

16. The curable composition of claim 1, further comprising a reinforcing silica.

17. The curable composition of claim 1, further comprising a filler.

18. The curable composition of claim 1, wherein the composition upon curing has a depth of cure of at least 5 mm after electromagnetic radiation exposure in the range of 400 to 500 nm at an intensity of 2 W/cm² for 5 seconds.

19. A method comprising:
applying the curable composition of claim 1 to a substrate; and
exposing the curable composition to electromagnetic radiation in the range of 340-550 nm at an intensity of 0.1-5 W/cm².

20.-21. (canceled)

22. An article comprising a first substrate having disposed thereon a curable composition comprising:
a urethane multifunctional (meth)acrylate;
a photo initiator system;
a moisture-cure initiator; and
an oligomer,
wherein the oligomer is represented by the formula 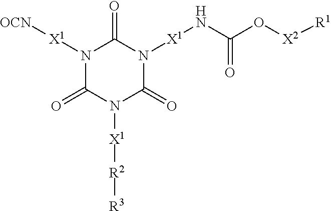
wherein
each X¹ is independently alkylene;
each X² is independently alkylene, polyether, polyester, or polyurethane;
R¹ is a (meth)acrylate;
R² is urethane or isocyanate; and
R³ is alkylene (meth)acrylate, polyester (meth)acrylate, polyether, polyester, polyurethane, or nothing, and
wherein the ratio of (meth)acrylate to isocyanate in the oligomer is 1:1 to 1:2.

23. The article of claim 22, further comprising a second substrate, wherein the reaction product of first components is sandwiched between the first and second substrates.

24. (canceled)

25. The article of claim 22, wherein the first substrate comprises steel.
